(19) United States
(12) Patent Application Publication
(10) Pub. No.: US 2020/0277850 A1
(43) Pub. Date: Sep. 3, 2020

(54) Unified User Interface for Optimizing Subsea Production and Drilling Systems

(71) Applicant: Marlon Jonathan Tesla, Houston, TX (US)

(72) Inventor: Marlon Jonathan Tesla, Houston, TX (US)

(21) Appl. No.: 16/290,878

(22) Filed: Mar. 2, 2019

(51) Int. Cl. E21B 47/00; E21B 44/00; G06F 16/28; G07C 3/04; G07C 3/14

(52) U.S. Cl. CPC E21B 47/0001; E21B 44/00; G07C 3/14; G06F 16/287; G07C 3/04; G06F 16/289

(57) ABSTRACT

The present invention relates to a computer, server or web application that provides a unified software platform and user interface for the means of optimizing subsea oil and gas production and drilling operations. In more detail, the present invention relates to a unified platform that performs condition monitoring for both real time and historical time series data as well as integration and access to unstructured data that may be related to but difficult to corelate automatically without false positives.

### BACKGROUND OF THE INVENTION

The present invention relates to a computer, server or web application that provides a unified software platform and user interface for the means of optimizing subsea oil and gas production and drilling operations. In more detail, the present invention relates to a unified platform that performs condition monitoring for both real time and historical time series data as well as integration and access to unstructured data that may be related to but difficult to corelate automatically without false positives such as but not limited to engineering documentation, maintenance activity, changes in operational conditions, schedules, risk assessments, spare lists, production forecasts and well performance reports.

The unified user interface utilizes data from any source or historian database. The system automatically identifies equipment and system anomalies and reports to expert users by exception so that the user may use other information to validate or invalidate the anomaly as new risk or failure. The unified user interface creates additional data through user interaction as well as automatically through processing of data through a digital asset model embodied within the system. The unified interface system generates anomaly linkage data objects (ALO) based upon identified anomalies identified by the condition monitoring algorithms and validated correlations by an expert user. This enables training of software algorithms that enable the system to classify future anomalies and suggest cause and action to users based on defined parameters and relevance within the historical anomaly linkage objects.

[DESCRIBE PRIOR ART AND ITS LIMITATIONS (AND IT MAY TAKE SEVERAL PARAGRAPHS)]. It is an object of the embodiments of the disclosed invention to solve this problem. Subsea production systems are uniquely designed to optimally produce or drill for oil and gas from reservoirs located under bodies of water up to depths of 10,000 meters. These systems have varying well depths and flow characteristics including high pressure and high temperature. The operational risks vary between assets making operational support and methods unique. The equipment used in subsea production and drilling systems generate time series data from sensors which are typically stored in data historians of some nature which is the source of input data for the disclosed invention.

Because every subsea asset is uniquely designed and or operates in varying conditions, the impact of equipment failure varies widely between assets in terms of operational risk. Because the amount of data generated by these systems is so vast it is difficult for users to sort through it fast enough to detect failures or problems. Custom digital asset models can be used to efficiently route and process the incoming data streams to produce useful insights and actionable information to users. The asset model is a collection of digital objects whereby each object includes parameters and methods that relate one or more tagged data time series data streams together to allow the detection of normal or anomalous behavior of that component. Each equipment object in the asset model contains information about the component such as but not limited to part number, serial number, description, and its position and dependencies within the overall system. The unified interface system provides the framework to efficiently develop and employ the asset models for the benefit of but not limited to integrity management, flow assurance, maintenance, facilities, activity planning and production optimization.

Subsea production and drilling system equipment may not be accessible to be inspected by humans while in service making remote monitoring for condition changes crucial. This disclosed invention is a software systems that interprets and routes data into a format that connects expert users with anomalous conditions in service so that the subsea assets can be more efficiently operated. The unified user interface system integrates all digital tools and information into one place to facilitate that need.

Both time series data and unstructured data such as but not limited to maintenance schedules, production forecasts, spare inventory lists and operator notes and reports are made available to the user in the disclosed invention. The unstructured data may be related but not easily corelated automatically. The uniqueness of the assets requires data linkages to be made between anomalies and operational activity to leverage computer or software algorithms to learn and add value in the future. The unified interface provides means for expert users to train the unified interface by generating Anomaly Linkage Objects (ALO). Anomaly Linkage Objects (ALO) is software object that is generated by the unified Interface when the asset model detects an anomaly in the data stream with the aide of the asset model. The system automatically populates the ALO with relevant information extracted from the asset model as well as the time frame of the occurrence. The ALO forms a structured data object which provides a means for users to integrate and link unstructured data of condition, activity and cause with anomalies found in time series data that are processed through the asset model. The structured ALO objects provides a means for the system to efficiently search, analyze and match similarities in characteristics of past ALO to avoid iteration through large datasets so that the system can alert users to but not limited to potential cause, action plan and operational risk.

Subsea operators find it difficult to leverage and integrate all data sources together to produce actionable information from it because the data resides in different systems and the data sets are extremely large. The unified interface overcomes that challenge by presenting all information to the user in one place and creates a manageable list of Anomaly Linkage Objects (ALO) which correlate equipment time series data in a format that can be leveraged by computers and software algorithms to retain and remind users of past experience while reducing false positives alerts over time.

There is a gap in the retention of experience and lessons learned gained by an organization as users move on or exit. Connecting the lessons and experience to the rest of the organization has proven to be an organizational challenge. New users tend to investigate and solve problems that appear to be new to them before inquiring if the problem has been seen or solved before. The unified interface circumvents that inefficiency by prompting the user to past experiences as it identifies anomalies by checking for similarities in the more manageable list of Anomaly Linkage Objects (ALO).
Another object of the present invention is to provide means of Learning retention and root cause recommendation based on multi-variate time series data pattern recognition provided by machine learning algorithms.
Another object of the present invention is to provide Automated Anomaly Detection in system and equipment performance using adapted subsea equipment performance algorithms and mathematical methods which include but are not limited to:
   Sensor deviation and drift detection
   Process value excursion detection
   SCM Communication Failure detection
   Hydraulic leak detection
   Electrical failures
   Valve Actuator failure detection
   Choke performance & Erosion detection
   Interlock bypass frequency
   Well ramp up performance
   Chemical injection efficiency
   Flow Assurance & Hydrate Risk KPI
   Multiphase flow meter performance
   BOP hydraulic ram performance
   Pilot valve pressure performance
   Hydraulic Flow meter totalizer performance
   Accumulator performance

Each of the above methods utilize customized mathematical methods, data filtering and relational behaviors, differential peak detection and rules sets embodied into the asset model which conform to the set-up of the equipment and the facility. Those skilled in the art of subsea systems, operations as well as data analytics will be able design and create relevant models for their application based on the teaching of the disclosed invention.
Another object of the present invention is to provide a means of recording, reporting and visualizing operational risk for the asset, business or environment through the aggregation of all standing risks and anomaly case files.
Another object of the present invention is to provide a graphical interface to link external systems or content to but not limited to design documentation, inspection records, videos, pictures, virtual reality, procedures, part numbers and serial numbers, contact information. This information falls into the category of relevant non-system generated data or information.
Another object of the present invention is to provide means to automatically track equipment usage including but not limited to pressure and temperature cycles, process excursions, over-pressure or under pressure events, fatigue and operational cycle counts. The system provide means to export that data to a central repository for integrity and reliability studies.
Another object of the present invention is to provide means for users to record and track anomaly case files which include characteristics of the anomaly, its potential impact to operations in the form of risk as well as ability to update case file with learnings discovered through troubleshooting and equipment recovery investigations.

This listing of some of the objects of the present invention is intended to be illustrative. Other objects, and the many advantages of the present invention, will be made clear to those skilled in the art in the following detailed description of the preferred embodiment(s) of the invention and in any drawing(s) appended hereto. Those skilled in the art will recognize, however, that the embodiment(s) of the present invention described herein are only examples of specific embodiment(s) of the invention, set out for the purpose of describing the making and using of the invention, and that the embodiment(s) shown and/or described herein are not the exclusive way(s) to implement the teachings of the present invention.

### BRIEF SUMMARY OF THE INVENTION

These several objects, and the advantages of the present invention, are met by providing a means for subsea practitioners to optimize subsea production and drilling operations through software data tools and interfaces that provide a means for performing condition monitoring and automated anomaly detection coupled with the ability to integrate and link operational activity and risk into generated Anomaly Linkage Object that can be used to encode references to lessons in anomaly case files, enrich data sets and enable computer and software algorithms to suggest action, cause or impact to similar events in the future.

In a second aspect, the present invention provides a means for transfer knowledge and experience from more experienced users into the disclosed invention so that less experienced users can leverage it as they use the disclosed invention.

In a third aspect, the present invention provides a means for providing detailed insights and information to remote personnel to permit better decisions whereby reducing risk by minimizing field personnel.

In a fourth aspect, the present invention provides a means for automatically generate new value adding data or insights derived from multiple data sources using a custom asset model and anomaly linkage objects.

Other objects, and the many advantages of the present invention, will be made clear to those skilled in the art in the following detailed description of the preferred embodiment(s) of the invention and the drawing(s) appended hereto. Those skilled in the art will recognize, however, that the embodiment(s) of the present invention that are described herein are only examples of specific embodiment(s), set out for the purpose of describing the making and using of the present invention, and that the embodiment(s) shown and/or described herein are not the only embodiment(s) of an apparatus and/or method constructed and/or performed in accordance with the teachings of the present invention. Further, although described herein as having particular application to certain operations, as noted above, those skilled in the art who have the benefit of this disclosure will recognize that the present invention may be utilized to advantage in many applications, the present invention being described with reference to the applications described herein for the purpose of exemplifying the invention, and not with the intention of limiting its scope.

### BRIEF DESCRIPTION OF THE DRAWINGS

The detailed description of some embodiments of the invention is made below with reference to the accompanying figures, in which:

FIG. 1 is a typical block diagram that shows where the disclosed invention would obtain the raw data from the subsea production or drilling system. The disclosed invention would interface with one or many database(s) or historian(s) that are provided or managed by others which is considered outside of the scope of the disclosed invention. Referring to FIG. 1 the location of the disclosed invention would reside in the client tools section.

FIG. 2 is a block diagram view of a typical asset model showing a conceptual block representation for each equipment object and how the parent/child relationship would be linked in accordance with the teachings of the present invention so that someone skilled in the art of subsea production systems would be able to understand and create. As disclosed each equipment object contains reference linkages of how it relates or connects to its parent/child objects within the rest of the system in the asset model. Each object will also have defined parameters and relationships between tagged time series data that relates how the data should behave normally relative to other data within the defined parameters of the asset model. Each object may have methods that employ mathematical filtering and correlation algorithms that can be individually called upon to furnish relevant information or results to the system which can be used in conjunction with results and information from other objects to provide data insights to the user as well as trigger the generation of new ALO objects.

FIG. 3 is a workflow diagram that teaches those skilled in the art how data is processed and integrated within the disclosed invention. As shown in FIG. 1 the invention obtains the raw time series data from available historians or databases as a client tool. The call out box 100 within FIG. 3 is where new data from the subsea system is accepted by this disclosed invention. The data is manipulated to fit into a structured format and stripped of bad data if required. Within call out box 200 of FIG. 3, The data is then collected into a buffer and then run through the asset model objects as defined within the relationship linkages of the asset model. The unified interface then requests roll up calculations to be made on each equipment object from child to parent level to detect anomalies against the defined parameters and behaviors in the asset model to form a list of anomalies linkage objects (ALO) as shown in block 300. Within block 400 the system compares the new ALO object to historic ALO within a database. The system then looks for matches and similarities within the ALO database and calculates a match score that is using methods and weighting that is tuned in a manner that someone skilled in the art of subsea would be able to derive to reduce false positives. The new ALO are then assigned a match score based on parameters and occurrence of the ALO against ALO in the database. If the match score of the historic ALO is above a defined threshold, the ALO will be linked to the new ALO and the defined cause and risk associated with the older ALO will be suggested to the user as shown in block 600 of FIG. 3. If within block 400 of FIG. 3 the new ALO does not have a match score greater than the defined threshold, the new ALO will be flagged to the user as a new unique ALO as shown in block 500 of FIG. 3.

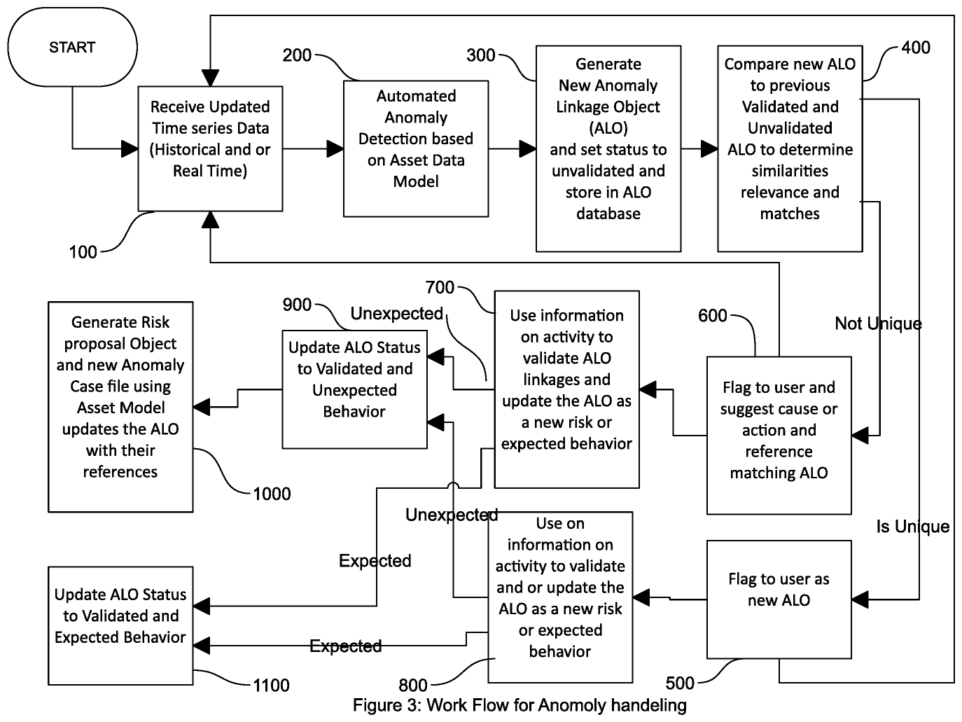

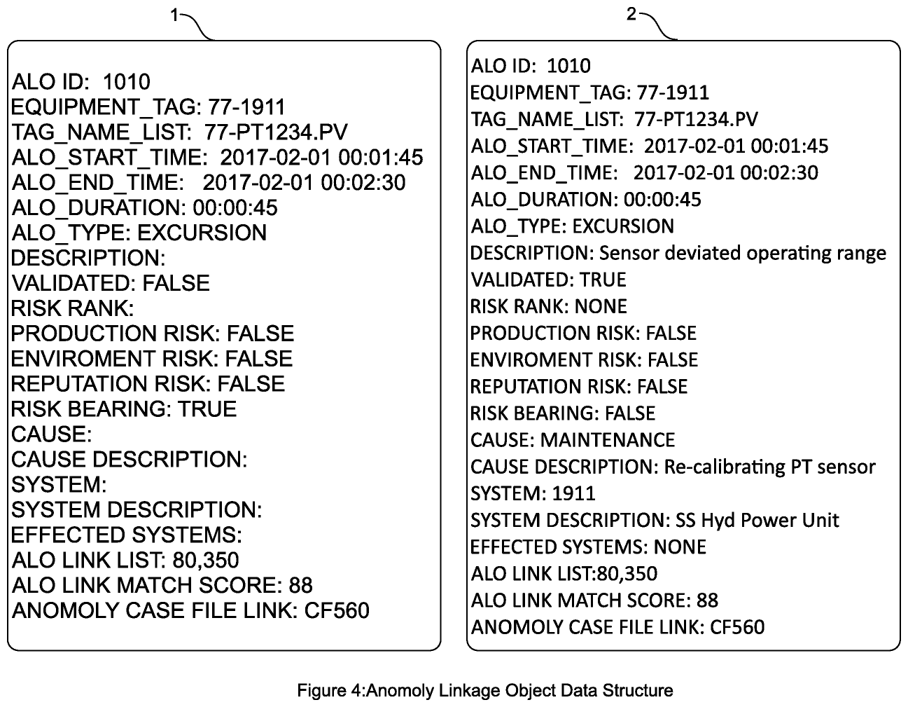

The disclosed invention then iterates around from either block 600 or 500 to block 100 and starts the automated process comprising of all the blocks outlined in red over again. When the expert user interacts with the disclosed invention, they do so through the provided unified interface to perform the action blocks outlined in black within FIG. 3.

Block 700 is where the disclosed invention presents new ALO to the user and provides linkages to past ALO and anomaly case files which include forms of unstructured free form data and information. The user can than use the data tools and access to other non-structured data and operational notes to validate the findings and linkages made by the invention in the ALO as well as update the fields and additional linkages and contextual information to the ALO.

Block 800 is where the disclosed invention presents the newly generated ALO to the user as a new unidentified ALO. The user can then use the data tools and access to other non-structured data and operational notes to validate and update the finding as a new risk or expected behavior. The user can then and link previous related ALO to the new ALO as well as update the fields and additional linkages and contextual information for the new ALO as shown in block 900, 1000 and 1100.

The red blocks combined with the user interaction in the black blocks formulates the basis for the learning and retention benefits of the disclosed invention. This method and system is novel and non-obvious to practitioners in the art of subsea production and drilling systems, and provides means for learning retention within a system for unique subsea production and drilling assets.

FIG. 4 is a depiction of an Anomaly Linkage Object (ALO) and the key parameters within the ALO object that are relatable to subsea production and drilling systems. Reference 1 within FIG. 4 shows an auto generated ALO object that is pre-populated by the system using information in the asset model (depicted in red font). Reference 2 within FIG. 4 shows the same ALO object updated after intervention by a user (depicted in green font). The purpose of the ALO is to provide a means to pinpoint the start and end time of an anomaly for quicker recall on large data sets as well as describe the nature of the anomaly for match scores. It links one or more related data tags involved in the system anomaly together as well as provide means for linking unstructured data in a structured way for future recall aided by computers. The ALO consists of key parameters such as tag names, time frames, descriptions and linkage list but are not limited to these parameters. Those familiar in the art will be able to identify what parameters are needed or useful. Table 1 below describes the basic parameters that make up an anomaly linkage object, one skilled in the art of subsea systems will be able to use the teachings and concepts within this invention disclosure to develop additional parameters that provide a structured linkage convention to leverage the power of computer algorithms and large datasets comprised of structured and unstructured data.

TABLE 1
Anomaly Linkage Object (ALO) Data structure Description

| Parameter Name | Description |
|---|---|
| ALO ID | Assigned Unique ID of the ALO object |
| EQUIPMENT_TAG | Equipment identification tag taken from the asset model |
| TAG_NAME_LIST | Tag name for the related data sources associated with the anomaly |
| ALO_START_TIME | The start timestamp of the identified anomaly |
| ALO_END_TIME | The end timestamp of the identified anomaly |
| ALO_DURATION | The time duration of the anomaly |
| ALO_TYPE | A key word associated with the type of anomaly which is used to sort and |
| | corelate between anomaly types. The key words used are defined in a |
| | convention appropriate for the systems being monitored. |
| DESCRIPTION | Description of the anomaly, this is a free field for user inputs |
| VALIDATED | This is a Boolean flag for if the ALO has been validated by a user |
| RISK RANK | This is a field to hold the risk ranking of the ALO, this field may be split |
| | into multiple fields to which represent severity and likelihood. |
| FINACIAL_RISK | This is a Boolean flag which is set TRUE if the ALO is identified to |
| | introduce a financial risk |
| ENVIROMENT_RISK | This is a Boolean flag which is set TRUE if the ALO is identified to |
| | introduce a environmental risk |
| REPUTATION_RISK | This is a Boolean flag which is set TRUE if the ALO is identified to |
| | introduce a reputational risk |
| RISK BEARING | This is a Boolean flag which is set TRUE if the ALO is identified to |
| | introduce measurable risk to operations |
| CAUSE | A key word associated with the cause of an anomaly which is used to sort |
| | and corelate between ALO objects. The key words used are defined in a |
| | convention appropriate for the systems being monitored. |
| | The cause key word is used as an input to the match score weighting system |
| CAUSE DESCRIPTION | This is free form cause of the description that will be used to suggest cause |
| | to users if future matching ALO are found. |
| SYSTEM | The system defined tag within the asset model |
| SYSTEM DESCRIPTION | The user-friendly description of the system pulled from the asset model |
| EFFECTED SYSTEMS | List of affected subs systems which form child relationships to the SYSTEM |
| | being affected. This is defined within the asset model. |
| ALO LINK LIST | This is a list variable that contains references to other ALO objects that have |
| | a match score greater than a defined threshold |
| ALO LINK MATCH SCORE | Tliis is a field which displays the highest match score to existing ALO |
| ANOMOLY CASE FILE LINK | This is a list of linkages in the form of URL or identifications of anomaly |
| | case files which contain ongoing structured and unstructured information |
| | related to findings and investigations of previous related anomalies. |

### DETAILED DESCRIPTION OF THE INVENTION

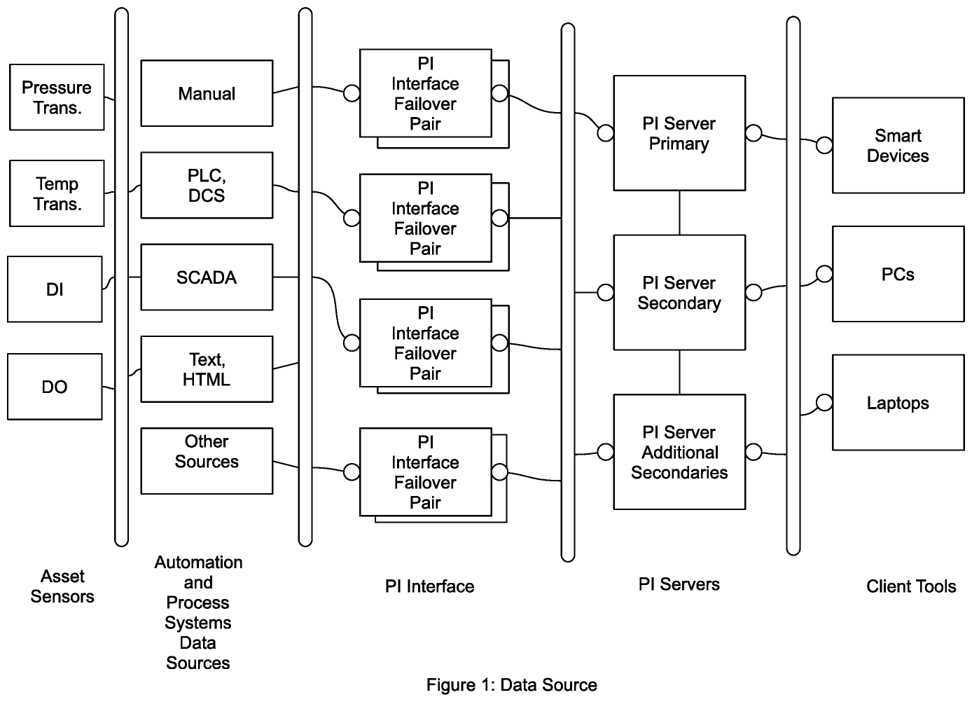

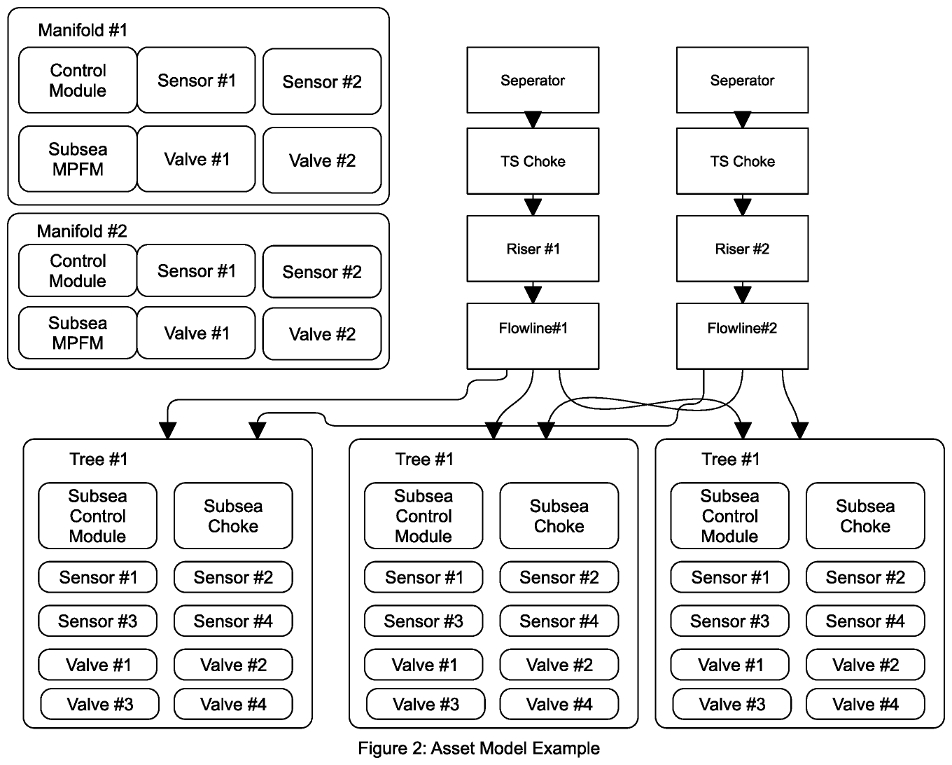

Referring now to the figures, a first embodiment of the of the present invention is indicated generally as a PC, Laptop or smart Device under the client tool section in FIG. 1. However, the disclosed invention can take the form of a server or web application, cloud service or a combination of all. In the embodiment shown, the present invention comprises of a software tool that includes a graphical user interface, computational capability, database(s), linkages to external unstructured data as well as access to one or more datastores that contain time series data from subsea production or drilling system assets.

Turning to these components in more detail, the disclosed invention is a software tool and system that integrates subsea system generated time series data and unstructured data into actionable information by means of processing the time series data through an asset model which is comprised of objects that digitally represent equipment hardware that is linked together through references within the objects which match the makeup for the subsea system. Each digital hardware object is embodied with operational parameters and operating limits and include mathematical methods for detecting unusual behavior. The methods may include filtering bad information, filling in data points for compressed data, imposing relational rules between multiple tags which those experienced in the art of subsea hardware and systems can derive and create based on these instructions. The asset model embodies methods for performing iterative calculations that may include Fourier transformations, differential peak searching and curve fitting to historical events for quick book marking in large historical data sets through the aide of the ALO data linkages.

The disclosed invention provides means for auto generating Anomaly Linkage Objects (ALO) which describe the nature of the anomaly and provides means of linking unstructured data to the anomaly instance by users. The ALO object creates a means to link anomaly instances with operational activity, cause, description and risk in a structured format to allow quick comparisons and book marking of previous events in large datasets. The ALO parameters include but are not limited to equipment TAG_NAME, SYSTEM, DESCRIPTION, VALIDATED, DOWNTIME, FINACIAL RISK, ENVIRONMENTAL RISK, REPUTATIONAL RISK, CAUSE, CAUSE DESCRIPTION, RELATED AOI, CASE FILE REFERENCE.

The disclosed invention provides means to automate notification through email or text message in real time upon detection of anomaly to users to prevent the need for users to continuously interact with the disclosed invention.

Those skilled in the art who have the benefit of this disclosure will also recognize that changes can be made to the component parts of the present invention without changing the manner in which those component parts function and/or interact to achieve their intended result. All such changes, and others that will be clear to those skilled in the art from this description of the preferred embodiment(s) of the invention, are intended to fall within the scope of the following, non-limiting claims.

What is claimed is:

1. A software tool and system comprising:
First a digital subsea asset model comprising multiple software objects that represent equipment arranged to match the makeup of a subsea production or drilling system. Each object is made up of parameters that include but are not limited to part numbers, serial numbers, descriptions, relationship linkages to parent and child objects in the system as well as methods to automatically detect normal or anomalous behavior of data flow through the relational definitions and operational limits embodied within the object(s) whereby the asset model provides means to accept and route data in an organized way to be processed to yield actionable information to users in real time or on historical data frames;
Second a function or process in which new data object described as an ALO in this disclosure is automatically or manually generated upon the detection of an anomaly which serves the purpose of creating a structured book mark that embodies relevant parameters to subsea production and drilling equipment and systems such as but not limited to tags and tag list, start and end time stamps, durations, system descriptions, cause descriptions, references to other data or events whereby allowing users to link unstructured data or operational condition relevant to the new ALO instances allowing efficient processing and comparison of historical ALO instances to current the current ALO instance within large data sets;
Third a method of automatically assigning new ALO described above a match score based upon the relevance and occurrence frequency of other historical ALO so that the disclosed invention can recommend cause and action to users upon detection of the new anomaly and become more accurate as additional user action is taken and lessons can be retained and automatically recalled for user by this disclosed invention.
